(19) United States
(12) Patent Application Publication
(10) Pub. No.: US 2016/0019660 A1
(43) Pub. Date: Jan. 21, 2016

(54) ONLINE PROPOSITION AND ANSWER SYSTEM

(71) Applicant: Vincent RENZI, Kirkland (CA)

(72) Inventor: Vincent RENZI, Kirkland (CA)

(21) Appl. No.: 14/793,316

(22) Filed: Jul. 7, 2015

Related U.S. Application Data
(60) Provisional application No. 62/026,193, filed on Jul. 18, 2014.

(51) Int. Cl. G06Q 50/00; G06Q 30/08; H04L 12/58; G06Q 20/40

(52) U.S. Cl. CPC G06Q 50/01; G06Q 20/405; G06Q 30/08; H04L 51/32; H04L 51/16

(57) ABSTRACT

Method and device for receiving propositions and answers online. At a server, a proposition message containing a proposition and a monetary award offer is received via a network interface module from a first user device. The proposition is associated with a category based on the content of the proposition message. The proposition message is sent via the network interface module to at least two other user devices associated with the category. Answers from the at least two other user devices are received at the server via the network interface module. The payment of a monetary award for the best answer among the provided answers is authorized.

### PRIORITY STATEMENT

This non-provisional patent application claims priority based upon the prior U.S. provisional patent application entitled “ONLINE QUESTION AND ANSWER SYSTEM”, application No. 62/026,193, filed Jul. 18, 2014, in the name of Vincent Renzi, which is incorporated by reference herein.

### TECHNICAL FIELD

The present invention relates to a system for managing an online social media platform and, more specifically, a social media platform for posting proposition and getting answers thereto.

### BACKGROUND

As the internet becomes more popular, more and more people turn to it for answers to their questions. One online resource is the traditional question-and-answer (Q&A) website, such as Yahoo! Answers. These Q&A websites enable users to collaborate by answering each others' questions. More specifically, Q&A websites typically enable their users to post questions, answer questions, and search or browse through the questions and answers of others.

The low quality of content on current Q&A websites is a well-known problem. There is a need for a new kind of Q&A system that improves the quality of the questions and answers being provided.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a method for receiving propositions and answers online. The method comprises, at a server, receiving via a network interface module a proposition message from a first user device, wherein the proposition message comprises a proposition and a monetary award offer. The method further comprises associating the proposition with a category based on the content of the proposition message. The method also includes sending via the network interface module the proposition message to at least two other user devices associated with the category. The method further includes, at the server, receiving via the network interface module answers from the at least two other user devices. The method also comprises authorizing payment of a monetary award for a best answer from the answers from the at least two other user devices.

For instance, the proposition may represent an opened questions, a closed question, a job proposition, a job request, a task request, a service offering, a service request, etc. The proposition may also be provided with an urgency flag and/or an importance flag. The monetary award may be varied (i.e., normalized based on importance) in view of the one or more flags.

Optionally, the method may further comprise a first user associated with the first user device, a second user that provided the best answer, and a first intermediary associated with the server. As a further option, authorizing payment of the monetary award may comprise the first intermediary authorizing the first user to pay the monetary award to the second user. And, the second user may optionally pay a portion of the monetary award to the first intermediary. Alternatively, authorizing payment of the monetary award may optionally comprise the first intermediary authorizing the first user to make a first payment to the first intermediary and the first intermediary to make a second payment to the second user. In this example, the first payment and the second payment may be equal, or alternatively the first payment may be greater than the second payment. As an alternative option, authorizing payment of the monetary award may comprise the first intermediary authorizing the first user to make a first payment to a second intermediary, the second intermediary to make a second payment to the second user and a third payment to the first intermediary, wherein the sum of the second payment and the third payment equals the first payment.

Optionally, the proposition message may further comprise an authorization to transfer the monetary award from the first user to the first intermediary to hold in trust. In this example, authorizing payment of the monetary award may optionally comprise the first intermediary paying the monetary award held in trust to the second user.

Optionally, the monetary award may be less than, equal to, or greater than the monetary award offer, wherein the monetary award may be determined based on at least the monetary award offer and the best answer.

As a further option, the method may comprising following receiving the answers sending via the network interface module the best answer to the first user device for display.

Optionally, authorizing payment of the monetary award may comprise receiving an authorization for payment of the monetary award from the first user device.

As an option, the method may further comprise prior to authorizing payment of the monetary award, selecting the best answer from the answers from the at least two other user devices. Selecting the best answer may comprise sending via the network interface module the answers from the at least two other user devices to the first user device, and receiving via the network interface module the best answer from the first user device.

Alternatively, the best answer may be selected by the server. Optionally, selecting the best answer may comprise, at the server, receiving a decision matrix from the first user device, and at the server, selecting the best answer based on the decision matrix.

As a further option, the proposition message may comprise at least one other monetary award offer, and the monetary award offer and the at least one other monetary award offer may each be associated with a different answer level.

A second aspect of the present invention is directed to a method for receiving propositions and answers online. The method comprises, at a server, receiving via a network interface module a proposition message from a first user device, wherein the proposition message comprises a proposition. The method further comprises associating the proposition with a category based on the content of the proposition message. The method also includes sending via the network interface module the proposition for display to at least two other user devices associated with the category. The method further includes, at the server, receiving via a network interface module a bid proposal from each of the at least two other user devices, wherein the bid proposal comprises a bid amount. And the method further comprises, following reception of an answer from a winning user device selected from among the at least two other user devices, authorizing payment of a monetary award towards the winning user device.

For instance, the proposition may represent an opened questions, a closed question, a job proposition, a job request, a task request, a service offering, a service request, etc. The proposition may also be provided with an urgency flag and/or an importance flag. The monetary award may be varied (i.e., normalized based on importance) in view of the one or more flags.

The reception of the answer from the winning user device may comprise sending via the network interface module an answer request to the winning user device, receiving at the server via the network interface module the answer from the winning user device, and sending via the network interface module the answer to the first user device for display.

Authorizing payment of the monetary award may optionally comprise receiving via the network interface module an authorization for payment of the monetary award from the first user device.

Optionally, the method may further comprise a first user associated with the first user device, a second user that provided the best answer, and a first intermediary associated with the server. As a further option, authorizing payment of the monetary award may comprise the first intermediary authorizing the first user to pay the monetary award to the second user. The method may further comprise the second user paying a portion of the monetary award to the first intermediary. As an alternative option, authorizing payment of the monetary award may comprise the first intermediary authorizing the first user to make a first payment to the first intermediary and the first intermediary to make a second payment to the second user. In this example, the first payment and the second payment may be equal, or alternatively the first payment may be greater than the second payment. As a further alternative, authorizing payment of the monetary award may comprise the first intermediary authorizing the first user to make a first payment to a second intermediary, the second intermediary to make a second payment to the second user and a third payment to the first intermediary, wherein the sum of the second payment and the third payment equals the first payment.

Alternatively, the proposition message may comprise an authorization to transfer the monetary award from the first user to the first intermediary to hold in trust. In this example, authorizing payment of the monetary award may optionally comprise the first intermediary paying the monetary award held in trust to the second user.

The monetary award may be less than, equal to, or greater than the bid amount from the winning user device, wherein the monetary award may be determined based on at least the bid amount of the winning user device and the answer.

Optionally, the winning user device may be selected based at least on the bid amounts. As a further option, selecting the winning user device may comprise sending via the network interface module the bid proposals from the at least two other user devices to the first user device, and receiving via the network interface module the winning user device from the first user device.

Alternatively, the winning user device may be selected by the server. Optionally, selecting the winning user device may comprise receiving via the network interface module a decision matrix from the first user device, and at the server, selecting the winning user device based on the decision matrix.

Optionally, the bid proposals may each contain at least one other bid amount, and the bid amount and the at least one other bid amount may each be associated with different answer levels.

A third aspect of the present invention is a network node device. The network node device comprises a network interface module for receiving a proposition message from a first user device, wherein the proposition message comprises a proposition. The network interface module is further for sending the proposition for display to at least two other user devices. The network interface module is also for receiving a bid proposal from each of the at least two other user devices, wherein the bid proposal comprises a bid amount. The network node device further comprises a processor module for associating the proposition with a category based on the content of the proposition message. The processor module is further for selecting the at least two other user devices based at least on the category. The processor module is also for, following reception of an answer from a winning user device selected from among the at least two other user devices, authorizing payment of a monetary award towards the winning user device. Optional features related to the system are equivalent to the options described in relation to the second aspect of the present invention.

For instance, the proposition may represent an opened questions, a closed question, a job proposition, a job request, a task request, a service offering, a service request, etc. The proposition may also be provided with an urgency flag and/or an importance flag. The monetary award may be varied (i.e., normalized based on importance) in view of the one or more flags.

### BRIEF DESCRIPTION OF THE DRAWINGS

Further features and exemplary advantages of the present invention will become apparent from the following detailed description, taken in conjunction with the appended drawings, in which:

FIG. 1 is a logical representation of an exemplary system in accordance with the teachings of the present invention;

FIG. 2 is a first flow chart of a first exemplary method in accordance with the teachings of the present invention;

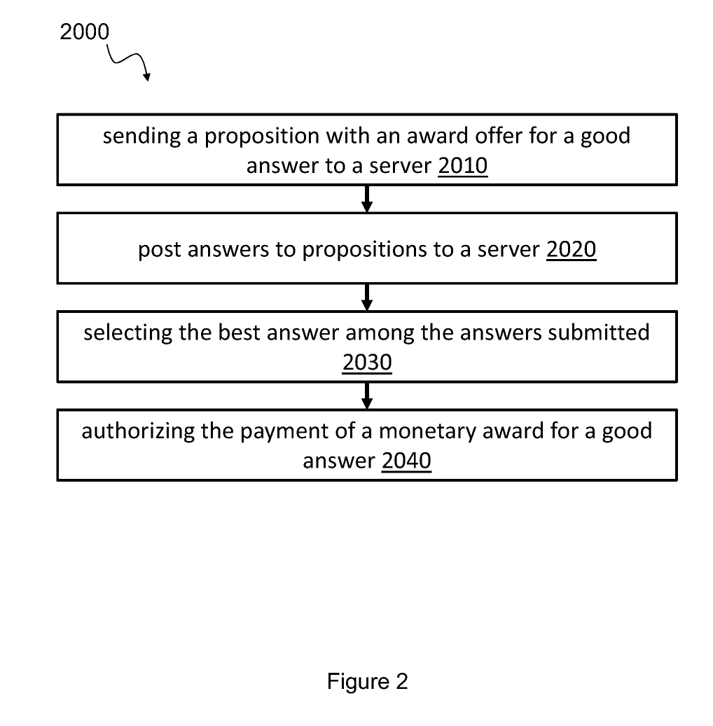

FIG. 3 is a second flow chart of a second exemplary method in accordance with the teachings of the present invention; and

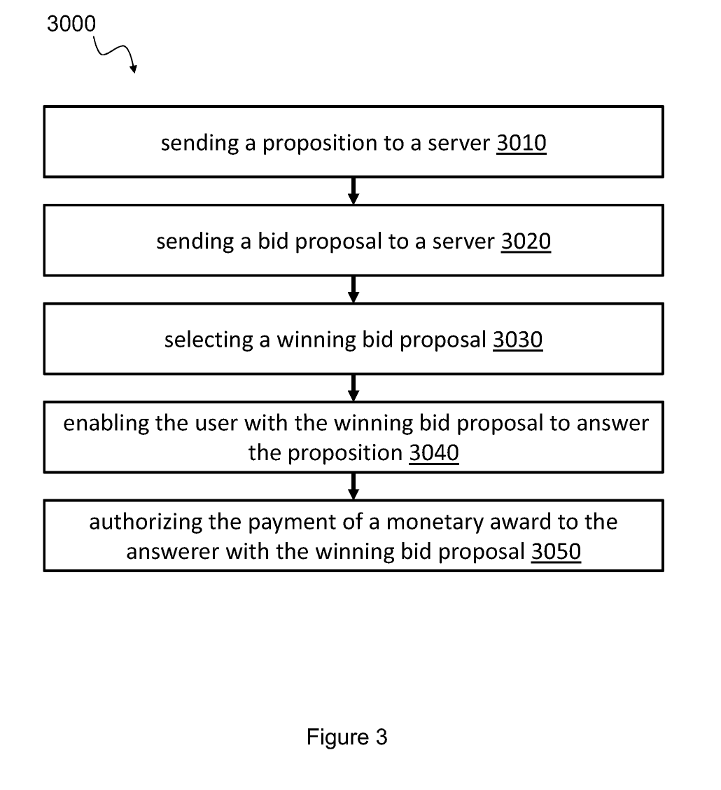

FIG. 4 is a third flow chart of a third exemplary method in accordance with the teachings of the present invention.

### DETAILED DESCRIPTION

Question-and-answer (Q&A) websites enable users to collaborate by answering each others' questions. More specifically, Q&A websites typically enable their users to post questions, answer questions, and search or browse through the questions and answers of others.

The low quality of content on current Q&A websites is a well-known problem. There is a need for a new kind of Q&A system that improves the quality of the questions and answers being provided.

The present invention includes a solution to this problem by enabling proposition makers, or question askers, to pay an award for good answers, which gives an incentive to potential answerers to provide high quality answers, and by rating both askers and answerers.

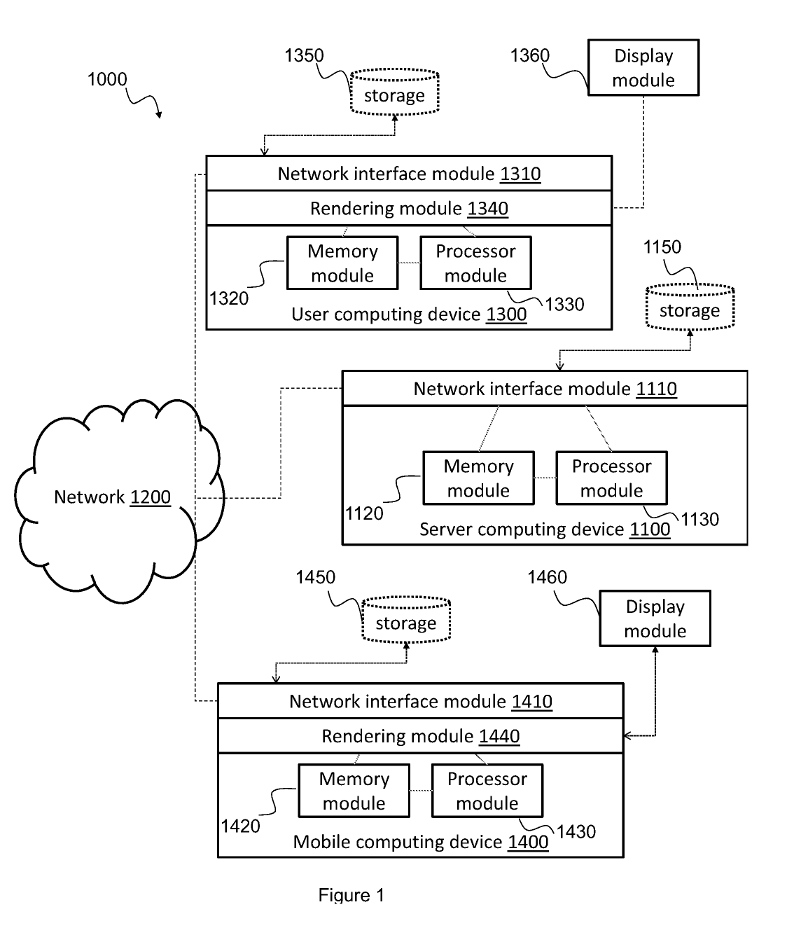

Reference is now made to the drawings, in which FIG. 1 presents a logical representation of an exemplary system 1000 in accordance with the teachings of the present invention. The exemplary system 1000 includes a server computing device 1100 for hosting an online proposition community. The server computing device 1100 comprises a storage module 1150, a memory module 1120, a processor module 1130, and a network interface module 1110.

The exemplary system 1000 may include a user computing device 1300 for permitting users to interact with the online proposition community. The user computing device 1300 comprises a storage module 1350, a memory module 1320, a processor module 1330, a network interface module 1310, and a rendering module 1340 (which may be a dedicated module, as illustrated in the example of FIG. 1, or a sub-module of the processor module 1330). The exemplary system 1000 may also include a display module 1360 (e.g., connected to the user computing device 1300 or integrated (not shown) with the user computing device 1300).

The exemplary system 1000 may include a mobile computing device 1400 for permitting users to interact with the online proposition community. The mobile computing device 1400 comprises a storage module 1450, a memory module 1420, a processor module 1430, a network interface module 1410, and a rendering module 1440 (which may be a dedicated module, as illustrated in the example of FIG. 1, or a sub-module of the processor module 1430). The exemplary system 1000 may also include a display module 1460 (e.g., integrated with the mobile computing device 1400).

The exemplary system 1000 includes a network 1200, which may be used to connect the server computing device 1100 with the user computing device 1300 and/or the mobile computing device 1400. The network 1200 may also be used for connecting to display devices, accessing storage, or accessing other nodes.

In embodiments of the present invention, an exemplary method 2000 is provided for enabling users to post propositions to the online proposition community. The user computing device 1300 may send a request message or request signal over the network 1200 to the server computing device 1100. The server computing device 1100 may then send a response signal or response message over the network 1200 to the user computing device 1300 containing instructions for rendering a Graphical User Interface (GUI). The user computing device 1300 renders the GUI on the display module 1360 using the rendering module 1340. In one embodiment, the proposition asker enters her proposition and the monetary award offer to be paid for a good answer using the GUI previously rendered or, in other embodiments, another graphical user interface otherwise provided for that purpose on the computing device 1300. Alternatively, the proposition asker may enter more than one monetary award offer, where each monetary award offer is associated with a different level of answer. For instance, the higher quality the answer received, the greater the monetary award might be. The user computing device 1300 sends a proposition message over the network 1200 to the server computing device 1100 including the proposition and monetary award offer 2010. The server computing device 1100 may store the proposition and monetary award offer in the storage module 1150. The proposition asker may associate the proposition with a category such that the category of the proposition is included in the signal or message sent from the computing device 1300 to the server computing device 1100 over the network 1200. Alternatively, the server computing device 1100 may associate the proposition with a category on its own.

For instance, the proposition may represent an opened questions, a closed question, a job proposition, a job request, a task request, a service offering, a service request, etc. The proposition may also be provided with an urgency flag and/or an importance flag. The monetary award may be varied (i.e., normalized based on importance) in view of the one or more flags.

In the exemplary method 2000 a further step is provided for enabling users to post answers to propositions to a server of an online proposition community 2020. The user computing device 1300 sends a request message or request signal over the network 1200 to the server computing device 1100. The server computing device 1100 sends a response signal over the network 1200 to the user computing device 1300 containing the proposition messages and, optionally, instructions for rendering a GUI. The propositions to be answered may be restricted to one or more categories of propositions. The categories may, for example, be categories of interest to the answerer or categories of propositions for which the answerer is ready to provide an answer (e.g., categories for which the answerer is an expert). The user computing device 1300 renders the GUI on the display module 1360 using the rendering module 1340. The answerer enters her answer to one of the propositions. The user computing device 1300 sends a message or signal over the network 1200 to the server computing device 1100 including the answer to the proposition. The server computing device 1100 may store the answer to the proposition in the storage module 1150. There may be more than one answerer and/or more than one answer for a given proposition.

In the exemplary method 2000 a further step is provided for selecting the best answer among the answers submitted 2030. The user computing device 1300 sends a request message or request signal over the network 1200 to the server computing device 1100. The server computing device 1100 sends a response message or response signal over the network 1200 to the user computing device 1300 containing the answers provided to her proposition and, optionally, instructions for rendering a GUI. The user computing device 1300 renders the GUI on the display module 1360 using the rendering module 1340. In one embodiment, the user computing device 1300 sends a signal or message over the network 1200 to the server computing device 1100 including the best answer. Alternatively, the server computing device 1100 may select the best answer without any input from the proposition asker. In an alternative embodiment, the proposition asker may submit a decision matrix to the server computing device 1100 via the network 1200, which the server computing device 1100 uses to select the best answer. The server computing 1100 may then send the best answer selected to the user computing device 1300 via the network 1200, and it may send a notification to the proposition answerer that provided the best answer via the network 1200. The server computing device 1100 may further store the best answer in the storage module 1150.

In the exemplary method 2000 a further step is provided for authorizing the payment of a monetary award for a good answer 2040. The authorization of the payment involves at least three parties: the proposition asker, the answerer, and the intermediary, which is an entity associated with the server computing device 1100. In the preferred embodiment, once the best answer has been selected, the intermediary sends a notification to the proposition asker authorizing the payment of the monetary award to the answerer. The notification may include the payment details of the answerer. The proposition asker then pays the monetary award directly to the answerer. The answerer may then pay a portion of this award to the intermediary. Or alternatively, the proposition asker may pay a portion of the award to the intermediary. In an alternative embodiment, the intermediary authorizes the proposition asker to pay the entire award to the intermediary, then the intermediary pays all or part of the monetary award to the answerer. In a further embodiment, the intermediary authorizes the proposition asker to pay the entire award amount to a third party, such as a bank or online payment service, and then the third party pays the award amount to the answerer. Or alternatively, the third party pays part of the award to the answerer and part to the intermediary. In an alternative embodiment, the proposition asker transfers the award amount to the intermediary to hold in trust when the proposition is first posed, for example within the proposition message. In this example, authorizing payment of the award amount comprises the intermediary releasing some or all the funds held in trust to the answerer. The proposition asker may pay a monetary award that is greater than, less than, or equal to the monetary award offered based on the quality of the answer provided. Alternatively, the proposition asker may authorize the intermediary or the third party payment service to pay the answerer.

In embodiments of the present invention, an exemplary method 3000 is provided for enabling users to bid on propositions to answer on the online proposition community. The asker's user computing device 1300 sends a signal containing a proposition 3010 to the server computing device 1100 via the network 1200. The answerer's user computing device 1300 sends a request signal or request message over the network 1200 to the server computing device 1100. The server computing device 1100 sends a response signal or response message over the network 1200 to the user computing device 1300 containing propositions to be answered and, optionally, instructions for rendering a GUI. The user computing device 1300 renders the GUI on the display module 1360 using the rendering module 1340. The answerer bids on a proposition by entering a bid proposal, which includes a bid amount (i.e., the amount she would like to be paid to answer the proposition). The bid proposal may contain further information about the answerer, such as the answerer's expertise or profession. The user computing device 1300 may automatically add such information to the bid proposal without the answerer having to add it herself (e.g., based on the answerer's pre-existing profile). Optionally, the bid proposal may contain more than one bid amount, where each bid amount is associated with a different answer level. For example, the answerer may offer to provide either a low quality answer or a high quality answer, where the low quality answer is associated with a lower bid amount than the high quality answer. The user computing device 1300 sends a signal over the network 1200 to the server computing device 1100 including the bid proposal 3020. The server computing device 1100 may add further information to the bid proposal, such as the answerer's expertise or a rating of the answerer (e.g., the rating may be based on historical data provided by users for a limited or unlimited period). The server computing device 1100 may store the bid proposal in the storage module 1150. In the exemplary method, the server computing device 1100 selects the winning bid proposal based on the bid amounts alone 3030. In selecting the winning bid proposal, the server computing device 1100 may use one of several possible standard auction algorithms that would be known to a skilled person. Alternatively, the server computing device 1100 may select the winning bid proposal using the bid amounts and the other information contained in the bid proposal, or based only on the other information contained in the bid proposal. The asker may submit a decision matrix to the server computing device 1100, which is used in selecting the winning bid proposal. In an alternative embodiment, the server computing device 1100 may send the bid proposals to the asker's user computing device 1300 via the network 1200. The asker may then select the winning bid proposal from among the submitted bid proposals. The user computing device 1300 may then send the winning bid proposal to the server computing device 1100 via the network 1200. The server computing device 1100 may store the winning bid proposal in the storage module 1150.

In the exemplary method 3000 a further step is provided for enabling the user with the winning bid proposal to answer the proposition 3040. The server computing device 1100 sends a signal over the network 1200 to the user computing device 1300 containing the information that the answerer's bid proposal has won, a request for an answer, and, optionally, instructions for rendering a GUI. The user computing device 1300 renders the GUI on the display module 1360 using the rendering module 1340. The answerer enters her answer to the proposition using the GUI. The user computing device 1300 sends a signal or message over the network 1200 to the server computing device 1100 containing the answer to the proposition. The server computing device 1100 may store the answer in the storage module 1150. Upon receiving the answer, the server computing device 1100 may send a signal or message over the network 1200 to the asker's user computing device 1300 containing the answer to the proposition. Alternatively, the server computing device 1100 may wait until the asker's user computing device 1300 requests the answer before sending the message or signal.

In the exemplary method 3000 a further step is provided for authorizing the payment of a monetary award to the answerer with the winning bid proposal 3050. The authorization of the payment involves at least three parties: the proposition asker, the answerer, and the intermediary, which is an entity associated with the server computing device 1100. In the preferred embodiment, once the winning bid proposal has been selected and an answer has been provided, the intermediary sends a notification to the proposition asker authorizing the payment of the monetary award to the answerer. The notification may include the payment details of the answerer. The proposition asker then pays the monetary award directly to the answerer. The answerer may then pay a portion of this award to the intermediary. Or alternatively, the proposition asker may pay a portion of the award to the intermediary. In an alternative embodiment, the intermediary authorizes the proposition asker to pay the entire award to the intermediary, then the intermediary pays all or part of the monetary award to the answerer. In a further embodiment, the intermediary authorizes the proposition asker to pay the entire award amount to a third party, such as a bank or online payment service, and then the third party pays the award amount to the answerer. Or alternatively, the third party pays part of the award to the answerer and part to the intermediary. In an alternative embodiment, the proposition asker transfers the award amount to the intermediary to hold in trust when the winning bid proposal is selected, or alternatively when the proposition is first posed. In this example, authorizing payment of the award amount comprises the intermediary releasing the funds held in trust to the answerer. The proposition asker may pay a monetary award that is greater than, less than, or equal to the bid amount based on the quality of the answer provided. Alternatively, the proposition asker may authorize the intermediary or the third party payment service to pay the answerer. For example, the user computing device 1300 may send a signal or message over the network 1200 to the server computing device 1100 including the amount of money to be paid for the answer and payment information. The server computing device 1100 processes the payment of the monetary award and may store the award paid in the storage module 1150.

In embodiments of the present invention, an exemplary method is provided for rating users. In this exemplary embodiment, the server computing device 1100 automatically calculates a rating for each user based on one or more of the following data stored in the storage module 1150: the total amount paid to other users, the average award amount promised per proposition, the percentage of transactions completed or canceled, the average difference between amounts promised and amounts paid, the total number of awards offered, the highest and lowest nominal awards, the user's general navigational activity, the number of complaints or reports against the user, and rating information inputted by users of the website. The rating may relate to a user's ability to answer propositions. Alternatively, the rating may relate to a user's reliability in paying monetary awards for answers.

In embodiments of the present invention, an exemplary method is provided for storing the academic and employment credentials of answerers. The user computing device 1300 sends a request signal or request message over the network 1200 to the server computing device 1100. The server computing device 1100 may then send a response signal or response message over the network 1200 to the user computing device 1300 containing instructions for rendering a GUI. The user computing device 1300 renders the GUI on the display module 1360 using the rendering module 1340. The user computing device 1300 sends a signal or message over the network 1200 to the server computing device 1100 including the academic and employment credentials of the answerer. The server computing device 1100 stores the academic and employment credentials in the storage module 1150.

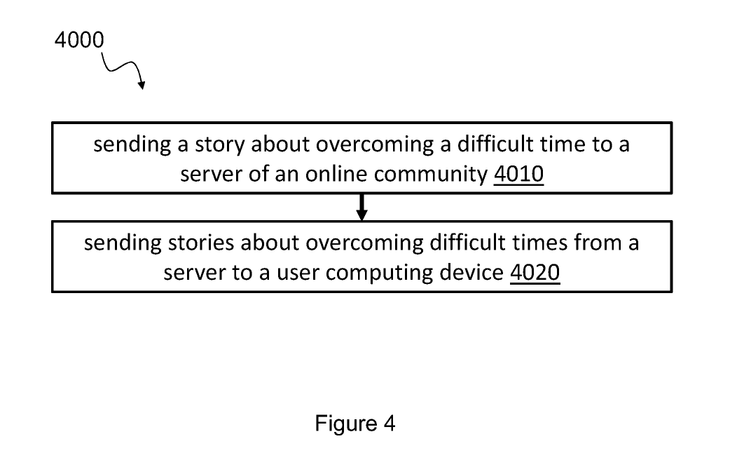

In embodiments of the present invention, an exemplary method 4000 is provided for enabling users to post stories about overcoming difficult times in their lives to an online community, as depicted in FIG. 4. The user computing device 1300 sends a request signal or request message over the network 1200 to the server computing device 1100. The server computing device 1100 may send a response signal or response message over the network 1200 to the user computing device 1300 containing instructions for rendering a GUI. The user computing device 1300 renders the GUI on the display module 1360 using the rendering module 1340. The user enters her story. The user computing device 1300 sends a signal or message 4010 to the server computing device 1100 including the user's story. The server computing device 1100 stores the story in the storage module 1150.

The exemplary method 4000 is also for enabling users to read the stories of other users about overcoming difficult times in their lives. The user computing device 1300 sends a request signal or request message over the network 1200 to the server computing device 1100. The server computing device 1100 sends a response signal or response message over the network 1200 to the user computing device 1300 containing the stories of other users organized by topic and, optionally, instructions for rendering a GUI. The user computing device 1300 renders the GUI 4020 containing the stories on the display module 1360 using the rendering module 1340.

Skilled persons will readily understand that a mobile computing device 1400 plays the same role and has the same functions as the user computing device 1300 in the foregoing. Skilled persons will readily understand that there could be more than one user computing device 1300 or mobile computing device 1400. Skilled persons will readily understand that there could be more than one server computing device 1100. A processor module may represent a single processor with one or more processor cores or an array of processors, each comprising one or more processor cores. A memory module may comprise various types of memory (different standardized or kinds of Random Access Memory (RAM) modules, memory cards, Read-Only Memory (ROM) modules, programmable ROM, etc.). Storage devices module may represent one or more logical or physical as well as local or remote hard disk drive (HDD) (or an array thereof). The storage devices module may further represent a local or remote database made accessible to one or more network nodes by a standardized or proprietary interface. A network interface module may represents at least one physical interface that can be used to communicate with other network nodes. The network interface module may be made visible to the other internal modules through one or more logical interfaces. The actual stacks of protocols used by the physical network interface(s) and/or logical network interface(s) of the network interface module do not affect the teachings of the present invention. The variants of processor module, memory module, network interface module and storage devices module usable in the context of the present invention will be readily apparent to persons skilled in the art. Likewise, even though explicit mentions of the memory module and/or the processor module are not made throughout the description of the present examples, persons skilled in the art will readily recognize that such modules are used in conjunction with other modules of the network node to perform routine as well as innovative steps related to the present invention. Various network links may be implicitly or explicitly used in the context of the present invention. While a link may be depicted as a wireless link, it could also be embodied as a wired link using a coaxial cable, an optical fiber, a category 5 cable, and the like. A wired or wireless access point may be present on the link between. Likewise, any number of routers may be present and part of the link, which may further pass through the Internet. The present invention is not affected by the way the different modules exchange information between them. For instance, the memory module and the processor module could be connected by a parallel bus, but could also be connected by a serial connection or involve an intermediate module without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for receiving propositions and answers online, the method comprising:
at a server, receiving via a network interface module a proposition message from a first user device, wherein the proposition message comprises a proposition and a monetary award offer;
associating the proposition with a category based on the content of the proposition message;
sending via the network interface module the proposition message to at least two other user devices associated with the category;
at the server, receiving via the network interface module answers from the at least two other user devices; and
authorizing payment of a monetary award for a best answer from the answers from the at least two other user devices.

2. The method of claim 1, further comprising a first user associated with the first user device, a second user that provided the best answer, and a first intermediary associated with the server.

3. The method of claim 2, wherein authorizing payment of the monetary award comprises the first intermediary authorizing the first user to pay the monetary award to the second user.

4. The method of claim 3, wherein the second user pays a portion of the monetary award to the first intermediary.

5. The method of claim 2, wherein authorizing payment of the monetary award comprises the first intermediary authorizing the first user to make a first payment to the first intermediary and the first intermediary to make a second payment to the second user.

6. The method of claim 5, wherein the first payment and the second payment are equal.

7. The method of claim 5, wherein the first payment is greater than the second payment.

8. The method of claim 2, wherein authorizing payment of the monetary award comprises the first intermediary authorizing the first user to make a first payment to a second intermediary, the second intermediary to make a second payment to the second user and a third payment to the first intermediary, wherein the sum of the second payment and the third payment equals the first payment.

9. The method of claim 2, wherein the proposition message further comprises an authorization to transfer the monetary award from the first user to the first intermediary to hold in trust.

10. The method of claim 9, wherein authorizing payment of the monetary award comprises the first intermediary paying the monetary award held in trust to the second user.

11. The method of claim 1, wherein the monetary award is less than, equal to, or greater than the monetary award offer, wherein the monetary award is determined based on at least the monetary award offer and the best answer.

12. The method of claim 1, further comprising following receiving the answers sending via the network interface module the best answer to the first user device for display.

13. The method of claim 12, wherein authorizing payment of the monetary award comprises receiving an authorization for payment of the monetary award from the first user device.

14. The method of claim 1, further comprising prior to authorizing payment of the monetary award, selecting the best answer from the answers from the at least two other user devices.

15. The method of claim 14, wherein selecting the best answer comprises:
sending via the network interface module the answers from the at least two other user devices to the first user device; and
receiving via the network interface module the best answer from the first user device.

16. The method of claim 14, wherein the best answer is selected by the server.

17. The method of claim 14, wherein selecting the best answer comprises:
at the server, receiving a decision matrix from the first user device; and
at the server, selecting the best answer based on the decision matrix.

18. The method of claim 1, wherein the proposition message comprises at least one other monetary award offer, and wherein the monetary award offer and the at least one other monetary award offer are each associated with a different answer level.

19. A method for receiving propositions and answers online, the method comprising:
at a server, receiving via a network interface module a proposition message from a first user device, wherein the proposition message comprises a proposition;
associating the proposition with a category based on the content of the proposition message;
sending via the network interface module the proposition for display to at least two other user devices associated with the category;
at the server, receiving via a network interface module a bid proposal from each of the at least two other user devices, wherein the bid proposal comprises a bid amount; and
following reception of an answer from a winning user device selected from among the at least two other user devices, authorizing payment of a monetary award towards the winning user device.

20. The method of claim 15, wherein reception of the answer from the winning user device comprises:
sending via the network interface module an answer request to the winning user device;
at the server, receiving via the network interface module the answer from the winning user device; and
sending via the network interface module the answer to the first user device for display.

21. The method of claim 20, wherein authorizing payment of the monetary award comprises receiving via the network interface module an authorization for payment of the monetary award from the first user device.

22. The method of claim 19, further comprising a first user associated with the first user device, a second user that provided the best answer, and a first intermediary associated with the server.

23. The method of claim 22, wherein authorizing payment of the monetary award comprises the first intermediary authorizing the first user to pay the monetary award to the second user.

24. The method of claim 23, wherein the second user pays a portion of the monetary award to the first intermediary.

25. The method of claim 22, wherein authorizing payment of the monetary award comprises the first intermediary authorizing the first user to make a first payment to the first intermediary and the first intermediary to make a second payment to the second user.

26. The method of claim 25, wherein the first payment and the second payment are equal.

27. The method of claim 25, wherein the first payment is greater than the second payment.

28. The method of claim 22, wherein authorizing payment of the monetary award comprises the first intermediary authorizing the first user to make a first payment to a second intermediary, the second intermediary to make a second payment to the second user and a third payment to the first intermediary, wherein the sum of the second payment and the third payment equals the first payment.

29. The method of claim 22, wherein the proposition message further comprises an authorization to transfer the monetary award from the first user to the first intermediary to hold in trust.

30. The method of claim 29, wherein authorizing payment of the monetary award comprises the first intermediary paying the monetary award held in trust to the second user.

31. The method of claim 19, wherein the monetary award is less than, equal to, or greater than the bid amount from the winning user device, wherein the monetary award is determined based on at least the bid amount of the winning user device and the answer.

32. The method of claim 19, wherein the winning user device is selected based at least on the bid amounts.

33. The method of claim 32, wherein selecting the winning user device comprises:
sending via the network interface module the bid proposals from the at least two other user devices to the first user device; and
receiving via the network interface module the winning user device from the first user device.

34. The method of claim 32, wherein the winning user device is selected by the server.

35. The method of claim 32, wherein selecting the winning user device comprises:
receiving via the network interface module a decision matrix from the first user device; and
at the server, selecting the winning user device based on the decision matrix.

36. The method of claim 19, wherein the bid proposals each contain at least one other bid amount, and wherein the bid amount and the at least one other bid amount are each associated with different answer levels.

37. A network node device comprising:
a network interface module for:
receiving a proposition message from a first user device, wherein the proposition message comprises a proposition;
sending the proposition for display to at least two other user devices;
receiving a bid proposal from each of the at least two other user devices, wherein the bid proposal comprises a bid amount; and
a processor module for:
associating the proposition with a category based on the content of the proposition message;
selecting the at least two other user devices based at least on the category; and
following reception of an answer from a winning user device selected from among the at least two other user devices, authorizing payment of a monetary award towards the winning user device.

38. The network node of claim 37, wherein the network interface module is further for:
sending an answer request to the winning user device;
receiving the answer from the winning user device; and
sending the answer to the first user device for display.

39. The network node of claim 38, wherein authorizing payment of the monetary award comprises receiving an authorization for payment of the monetary award from the first user device.

40. The method of claim 37, further comprising a first user associated with the first user device, a second user that provided the best answer, and a first intermediary associated with the server.

41. The network node of claim 40, wherein authorizing payment of the monetary award comprises the first intermediary authorizing the first user to pay the monetary award to the second user.

42. The network node of claim 41, wherein the second user pays a portion of the monetary award to the first intermediary.

43. The network node of claim 40, wherein authorizing payment of the monetary award comprises the first intermediary authorizing the first user to make a first payment to the first intermediary and the first intermediary to make a second payment to the second user.

44. The network node of claim 43, wherein the first payment and the second payment are equal.

45. The network node of claim 43, wherein the first payment is greater than the second payment.

46. The network node of claim 40, wherein authorizing payment of the monetary award comprises the first intermediary authorizing the first user to make a first payment to a second intermediary, the second intermediary to make a second payment to the second user and a third payment to the first intermediary, wherein the sum of the second payment and the third payment equals the first payment.

47. The network node of claim 40, wherein the proposition message further comprises an authorization to transfer the monetary award from the first user to the first intermediary to hold in trust.

48. The network node of claim 47, wherein authorizing payment of the monetary award comprises the first intermediary paying the monetary award held in trust to the second user.

49. The network node of claim 37, wherein the monetary award is less than, equal to, or greater than the bid amount from the wining user device, wherein the monetary award is determined based on at least the bid amount of the wining user device and the answer.

50. The network node of claim 37, wherein the winning user device is selected based at least on the bid amounts.

51. The network node of claim 50, wherein the network interface module is further for:
sending the bid proposals from the at least two other user devices to the first user device; and
receiving the winning user device from the first user device.

52. The network node of claim 50, wherein the processor module is further for selecting the winning user device.

53. The network node of claim 50, wherein:
the network interface module is further for receiving a decision matrix from the first user device; and
the processor module is further for selecting the winning user device based on the decision matrix.

54. The network node of claim 37, wherein the bid proposals each contain at least one other bid amount, and wherein the bid amount and the at least one other bid amount are each associated with different answer levels.
